(19) United States
(12) Patent Application Publication
(10) Pub. No.: US 2015/0029229 A1
(43) Pub. Date: Jan. 29, 2015

(54) Adjustable Size Scrollable Display

(71) Applicant: Sharp Laboratories of America, Inc., Camas, WA (US)

(72) Inventor: Apostolos Voutsas, Portland, OR (US)

(73) Assignee: Sharp Laboratories of America, Inc., Camas, WA (US)

(21) Appl. No.: 13/952,594

(22) Filed: Jul. 27, 2013

(51) Int. Cl. G06F 1/16; G09G 5/373

(52) U.S. Cl. CPC G06F 1/1652; G09G 5/373; G06F 1/1647
USPC 345/661; 345/667; 345/1.3

(57) ABSTRACT

A scrollable display is provided with an adjustable screen size and an associated image scaling method. The display includes a case or housing, with an exit slot. The display also includes a flexible electronic screen having an input to accept electronic image signals, and a surface to display images. A screen extension mechanism is embedded in the case and connected to the flexible electronic screen interior edge. The screen extension mechanism is configured to permit the extension of the flexible electronic screen, through an exit slot, into a plurality of exposed widths. An image scaler has an input to accept a screen width measurement corresponding to an exposed width of the flexible electronic screen. The image scaler has an output to supply electronic image signals scaled to the screen width measurement, to form an image on an exposed section of the flexible electronic screen.

### BACKGROUND OF THE INVENTION

1. Field of the Invention

This invention generally relates to electronic displays and, more particularly, to a flexible electronic screen capable of displaying a scalable image based upon screen extension.

2. Description of the Related Art

There are many applications in which it would be more convenient to have documents in an electronic format, instead of a paper medium. For example, schematics or blueprints commonly require large sheets of paper that are rolled and placed in cylindrical containers to carry around. For a typical project, several drawings are needed, which results in a significant volume of paper that must be carried around. Moreover, in a typical design scenario, a professional (e.g., architect, engineer, or construction professional) goes through several design revisions, for example, as a result of frequent back and forth with the client, before the design is finalized, with each version requiring a new set of drawings to be printed. Furthermore, during the execution phase of the project, changes on the fly are often required, based on unanticipated issues (e.g. in the case of remodeling or retrofit projects). These changes must be timely communicated to all trades involved in a project. When project changes are not properly communicated due to untimely updates to the schematics, the consequences are longer project timelines and added expenses.

All of the above-mentioned issues can be addressed by adopting a digital solution to documentation. For example, although blueprints themselves are typically prepared in the digital domain using specialized software (e.g. Auto-CAD), there is currently no means to have the equivalent of the paper-printed schematics, for use in the field or office, using a device that can display and allow changes to be captured and instantaneously transmitted to all stakeholders.

Therefore, it would be advantageous if a portable digital device existed that could provide a large display surface where drawings and schematics can be displayed and modified. It would be advantageous if the display could be rolled up when not needed, collapsing to a form-factor that is easy to carry and transport. Disclosed below are some technologies that can be adapted for this purpose.

FIG. 1 is a partial cross-sectional view of an electrophoretic display (EPD) (prior art). Electrophoretic display cells are manufactured using black and white pigments in a microencapsulated and electrically insulating oil. When a DC voltage is applied to a pixel, the black and the white particles are driven to opposite faces of the pixel, each attracted to a particular charge. The pigments tend to form a solid layer across the face of the microcapsule, with the pigment in the front of the cell hiding the pigment in the back. Continuous gray scale can be achieved by only partially driving the pigments across the cell gap. The particle movement is driven by an impulse (field×time) so that to first order the response time of the cell is given by d²/μV, where V is the applied voltage, μ is the electrophoretic mobility of the particle, and d is the cell gap. While EPDs have historically had the reputation of being slow, a cell with a 30-msec cell response at 15-V operation has been reported.

FIG. 2 is a partial cross-sectional view of an electrowetting (EW) display (prior art). Electrowetting pixels are an open-cell structure where a dyed-oil is transposed between a film covering a hydrophobic dielectric (no voltage) and partial sphere reduced to 20-30% of the pixel area (voltage). A rapid switching speed (˜10 microseconds (msec)) has been demonstrated for greater than 100 pixels per inch (ppi) pixels, although at lower resolutions the display may be slower since the oil film has to move a larger distance. Generally, electrowetting pixels respond quickly because over the same length scale it is typically 100 times faster to move the fluid with colorant inside, as opposed to electrophoretic where the colorant moves through the fluid itself. The pixels are not inherently bistable, although the power required to hold a pixel at a particular state is lower than the power to switch into that state. For a given operating voltage, the aspect ratio of the oil must be constant and therefore for greater 100 ppi pixels, the oil film is only 3-4 microns (μm) thick. Consequently, there is significant investment in oil-soluble dye development to meet pixel resolution requirements.

FIGS. 3A and 3B are partial cross-sectional views of conventional and multistable electrofluidic (EF) displays, respectively (prior art). Both types of electrofluidic pixels range from ˜20 to 70 μm thick. Both constructions use two electrowetting plates, but the nomenclature “electrofluidic” is used because there is a net liquid flow through microfluidic cavities. In FIG. 3A, voltage pulls a pigment dispersion into a viewable channel in approximately 20-40 milliseconds, displacing a black dyed oil (colored state). Similar to electrowetting, moving the colorant with the fluid is about 100 times faster than moving colorant through the fluid (electrophoretic). When the voltage is removed, surface tension drives the fluid back into an optically masked reservoir (black state). The device of FIG. 3B achieves bistable operation by using a viewable channel and hidden reservoir that are equal in geometry, thereby balancing the forces associated with surface tension. This is the first electrowetting or electrofluidic device capable of creating indefinitely stable gray-scale states with no holding voltage.

### SUMMARY OF THE INVENTION

Disclosed herein is a device with a flexible display surface connected to a housing unit in a manner that allows the flexible electronic screens to deploy from the housing and retract in the housing (through an entry/exit slit), on demand. Other aspects of the design permit the deployment of multiple flexible electronic screens, or flexible electronic screens that emulate the “feel” of a book or magazine. Furthermore, in a device comprising multiple flexible electronic screens, the flexible electronic screens can be tailor-made for different operations and functionality. For example, a first flexible electronic screen may be tailored for reading documents and a second flexible electronic screen tailored for higher resolution functions such as video and photo viewing, video-phone functions, etc.

The base unit or case, in addition to serving as housing for the rolled up flexible electronic screen, acts as a hub for various electronic components needed to control the operation of the display and the acquisition and distribution of its contents (e.g., WiFi connection, Bluetooth, etc.). When not needed deployed, the flexible electronic screen can be retracted back to the base unit. For example, the flexible electronic screen can be rolled to a compact cylindrical shape. The flexible electronic screen surface can function at lengths between its fully deployed and fully retracted states. The system automatically scales the presentation of content to the available display area. The flexible electronic screen surface may include a touch panel interface through which the user can provide input, access option menus and, generally, interact with the display. Wireless communication capabilities may also be included to upload digital content to the device, share content with other devices, and enable additional functionalities.

Accordingly, a scrollable display is provided with an adjustable screen size. The display includes a case, with a first exit slot. The display also includes a first flexible electronic screen having an interior edge, a width, an input to accept electronic image signals, and a surface to display images. A first screen extension mechanism is embedded in the case and connected to the first flexible electronic screen interior edge. The first screen extension mechanism is configured to permit the extension of the first flexible electronic screen, through the first exit slot, into a plurality of exposed widths. An image scaler has an input to accept a screen width measurement corresponding to an exposed width of the first flexible electronic screen. The image scaler has an output to supply electronic image signals scaled to the screen width measurement, to form an image on an exposed section of the first flexible electronic screen.

In one aspect, the case has a second exit slot and the scrollable display also includes a second flexible electronic screen having an interior edge, a width, an input to accept electronic image signals, and a surface to display images. A second screen extension mechanism is embedded in the case and connected to the second flexible electronic screen interior edge. The screen extension mechanism is configured to permit the extension of the second flexible electronic screen through the second exit slot. In one aspect, the image supplied to the second flexible electronic screen can be scale to fit the exposed section of screen.

Additional details of the above described display and a method for displaying an image having a selectable image width are provided below.

### BRIEF DESCRIPTION OF THE DRAWINGS

FIG. 1 is a partial cross-sectional view of an electrophoretic display (EPD) (prior art).

FIG. 2 is a partial cross-sectional view of an electrowetting (EW) display (prior art).

FIGS. 3A and 3B are partial cross-sectional views of conventional and multistable electrofluidic (EF) displays, respectively (prior art).

FIGS. 4A through 4D are, respectively, a partial cross-sectional and three plan views of a scrollable display with adjustable screen size.

FIG. 5 is a partial cross-sectional view of an exemplary detail of the first screen extension mechanism.

FIG. 6 is a partial cross-sectional view of a second exemplary detail of the first screen extension mechanism.

FIG. 7 is a partial cross-sectional view of a third exemplary detail of the first screen extension mechanism.

FIG. 8 is a plan view of a scrollable display with dual flexible electronic screens.

FIG. 9 is a schematic diagram depicting some exemplary electronic functions that may support any of the above-described displays.

FIGS. 10A and 10B are perspective views of an exemplary scrollable display in open and closed positions.

FIG. 11 is a perspective view of a scrollable display with two flexible electronic screens.

FIG. 12 is a perspective drawing depicting the scrollable display as an electronic blueprint device.

FIG. 13 is a perspective view of an exemplary flexible electronic screen.

FIG. 14 is a partial cross-sectional view of a flake display reflective device.

FIG. 15 is a partial cross-sectional view of the scrollable display with the flexible electronic screen partially retracted.

FIG. 16 is a flowchart illustrating a method for displaying an image having a selectable image width.

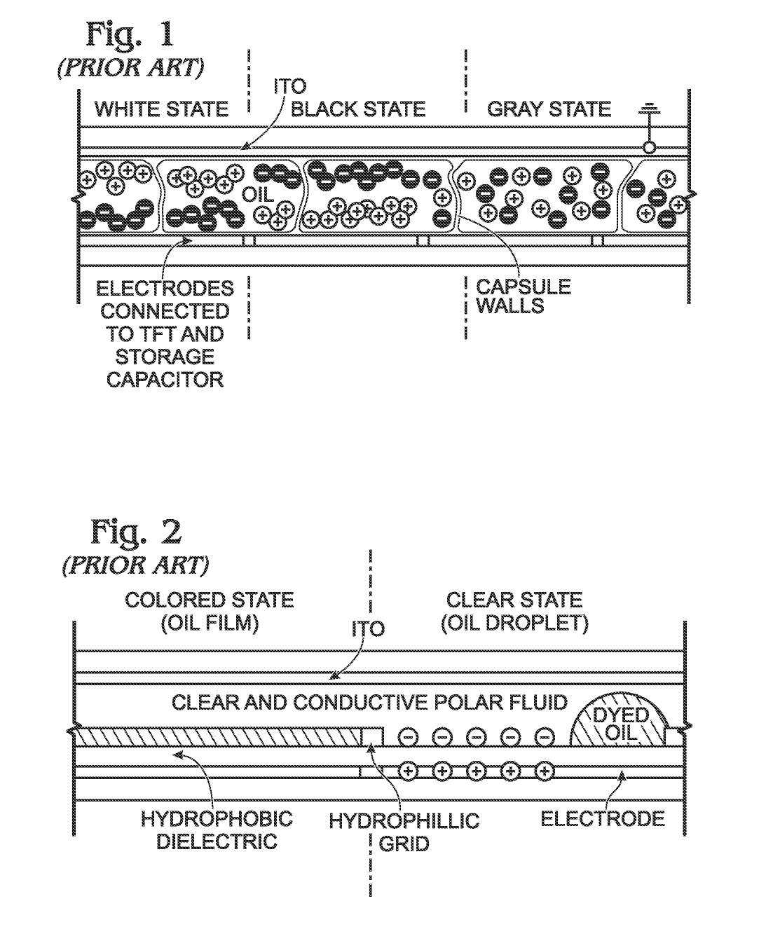

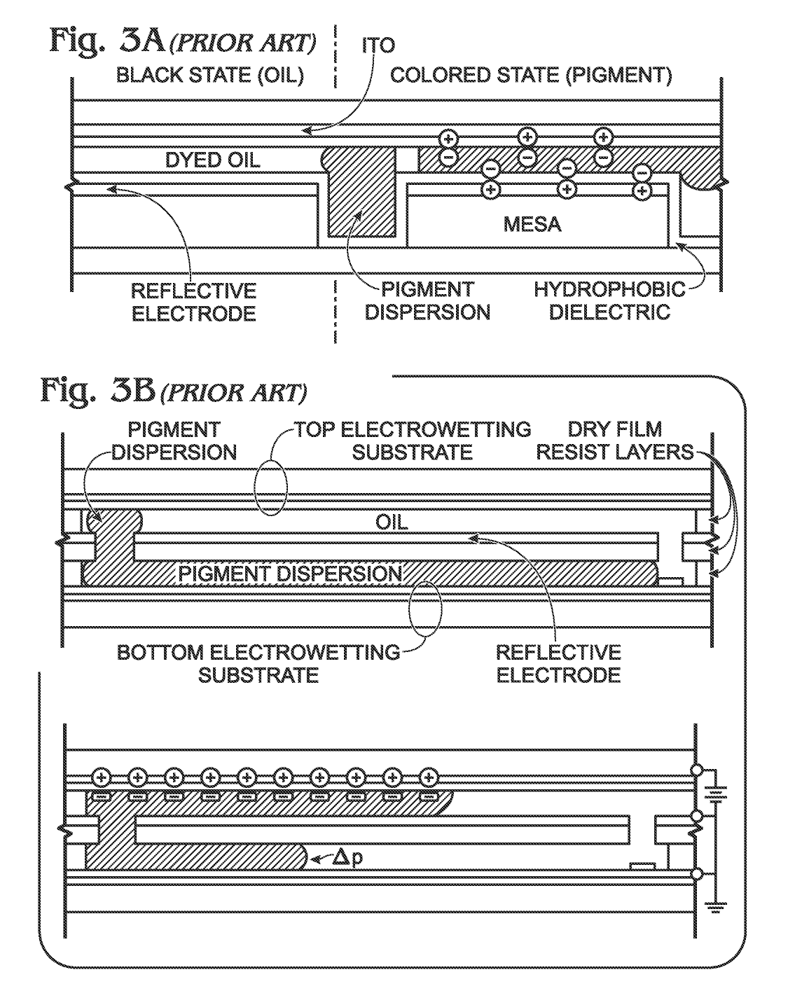

### DETAILED DESCRIPTION

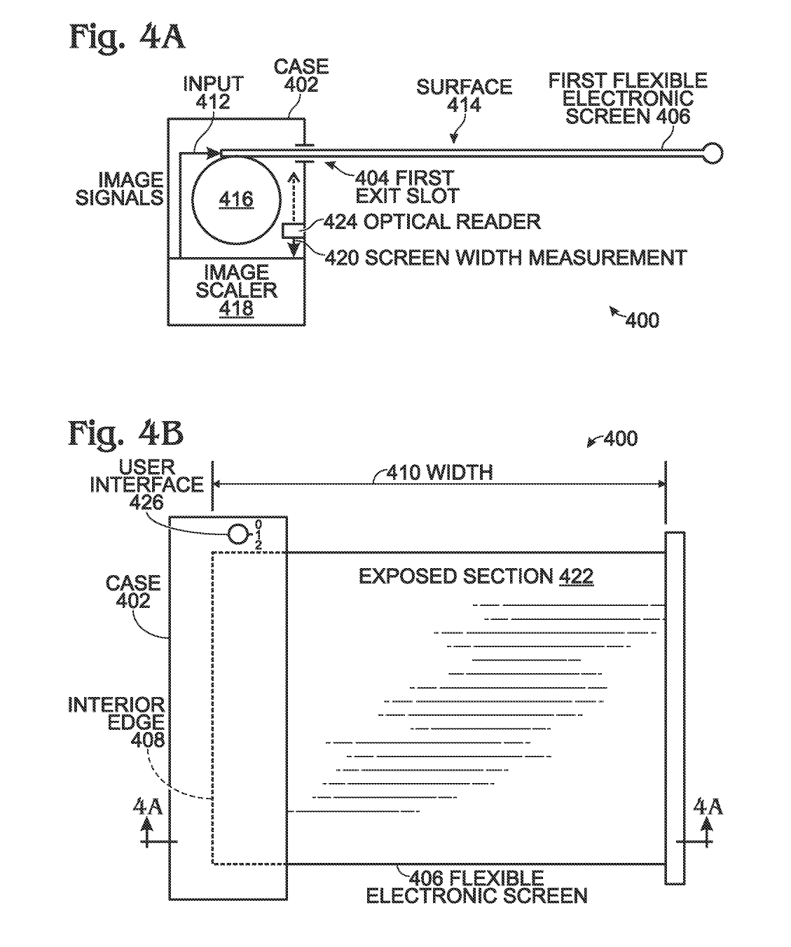

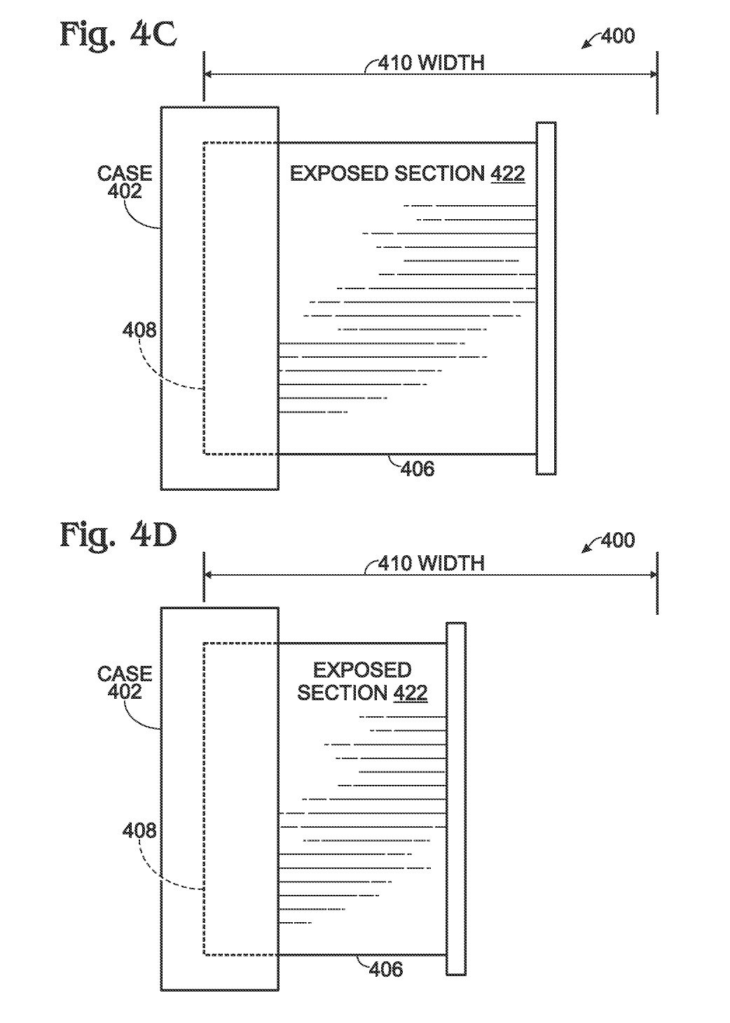

FIGS. 4A through 4D are, respectively, a partial cross-sectional and three plan views of a scrollable display with adjustable screen size. The display 400 comprises a case 402 including a first exit slot 404. A first flexible electronic screen 406 has an interior edge 408, a width 410, an input on line 412 to accept electronic image signals, and a surface 414 to display images. A first screen extension mechanism 416, shown as a cylinder, is embedded in the case 402 and connected to the first flexible electronic screen interior edge 408. The first screen extension mechanism 416 is configured to permit the extension of the first flexible electronic screen 406, through the first exit slot 404, in a plurality of exposed widths. In FIGS. 4A and 4B, the flexible electronic screen 406 is shown fully extended. An image scaler 418, which also may be referred to as a display controller, has an input on line 420 to accept a screen width measurement corresponding to an exposed width of the first flexible electronic screen, and an output on line 412 to supply electronic image signals scaled to the screen width measurement, to form an image on an exposed section 422 of the first flexible electronic screen. FIGS. 4C and 4D depict the flexible electronic screen partially extended to show different exposed sections 422.

In one aspect, the image scaler 418 accepts a predetermined discrete number of different screen width measurements. For example, the image scaler 418 may only accept three possible screen width measurements corresponding to the exposed sections 422 depicted in FIGS. 4B-4D. Alternatively, the image scaler 418 may accept a continuously sequential number of different screen width measurements between a maximum screen width measurement and a minimum screen width measurement. That is, any number of screen width measurements may be accepted between the minimum and maximum values.

In another aspect, the user deploys the flexible electronic screen to the length desired. The user then touches a touch sensor integrated on the flexible electronic screen surface at a point closest to the housing. This touch provides a length coordinate that is then used to compute the overall width of flexible electronic screen deployed. Once that information is available to the image scaler 418, the image is scaled and sent to the flexible electronic screen 406.

Similarly, the first screen extension mechanism 416 may extend exposed sections of flexible electronic screen a predetermined discrete number of different exposed sections or a continuously sequential number of different exposed sections between a minimum exposed section and a maximum exposed section. That is, the flexible electronic screen may be extended in a limited number of positions (e.g., 3) or be extended to any position between the minimum and maximum flexible electronic screen exposed width. Finally, the image scaler 418 may supply a predetermined discrete number of different scaled images or a continuously sequential number of different scaled images between a minimum sized image and a maximum sized screen image. That is, the image may be scaled to fit a limited number of exposed sections of the flexible electronic screen (e.g., 3), or the image may be scalable to fit any exposed section between the minimum and maximum sized flexible electronic screen exposed sections.

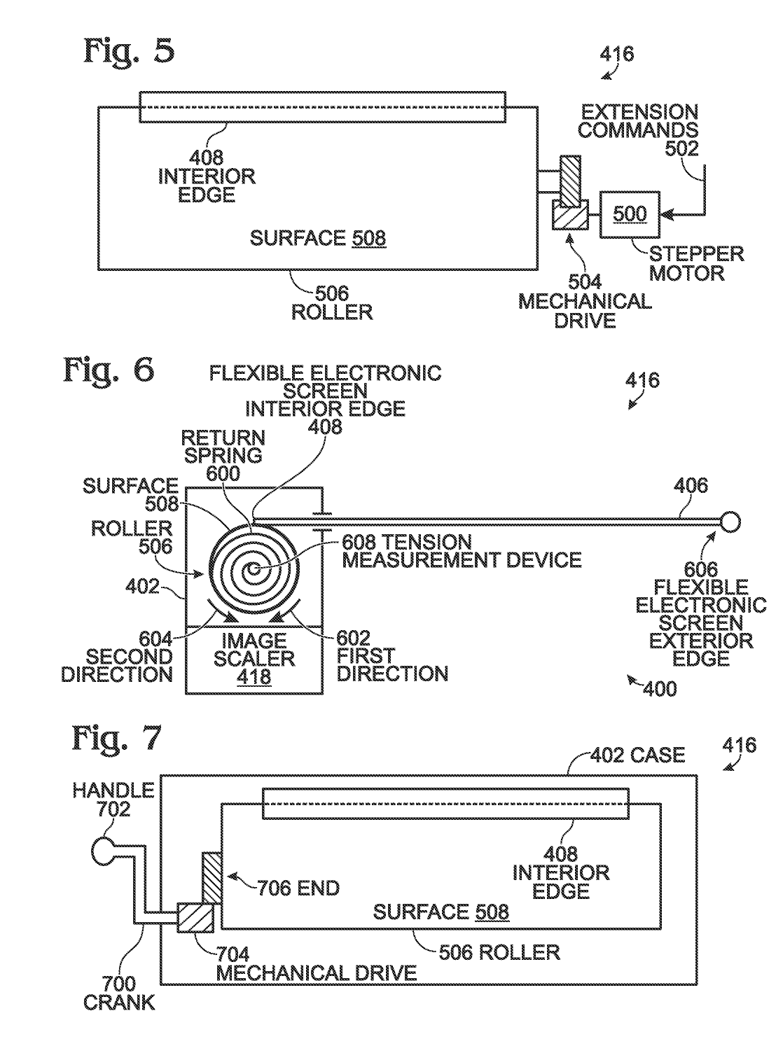

FIG. 5 is a partial cross-sectional view of an exemplary detail of the first screen extension mechanism. The first screen extension mechanism 416 includes a stepper motor 500 having an electronic interface on line 502 to accept extension commands, and a mechanical drive 504. A stepper motor (or step motor) is a brushless DC electric motor that divides a full rotation into a number of equal steps. The motor's position can then be commanded to move and hold at one of these steps without any feedback sensor (an open-loop controller). A roller 506 is connected to the stepper motor mechanical drive and has a surface 508 connected to the first flexible screen interior edge 408. The roller 506 is configured to rotate in response to extension commands, and the exposed section of the first flexible electronic screen (see FIGS. 4B-4D) is responsive to the rotation of the roller. In one aspect, the image scaler accepts screen width measurements from the stepper motor 500. That is, the stepper motor 500 is able to determine how far it has rotated in a particular direction, and this determination is supplied to the image scaler. More explicitly, the motor may be encoded to a specific length deployed/retracted per revolution. During deployment, the user starts the motor and has the option to stop it after a time period corresponding to an interval shorter or equal to the time it takes to fully deploy the screen. When the motor is stopped, a signal is transmitted from the motor encoder to the image scaler 418, with a notification of the width of the flexible electronic screen 406 that has been deployed. Alternatively, as shown in FIG. 4A, the image scaler 418 accepts screen width measurements from an optical reader 424, which may detect marks on the roller or on the flexible electronic screen 406.

Returning to FIG. 4B, the scrollable display 400 may further comprise a user interface 426, here depicted as a three-position mechanical dial. The user may have the option of selecting (i.e. using an analog or digital dial) the width of the deployment based on a number of predetermined options. Then, the motor deploys a width of flexible electronic screen corresponding to the selected option. That is, the user interface 426 has an output (on line 502, see FIG. 5) to supply the extension commands, and an input to accept user commands. The user commands may be a predetermined discrete number of user input options. As shown, three options (0, 1, and 2) are shown. Alternatively, the user interface may accept a continuously sequential number of user input options between a maximum exposure width and a minimum exposure width. For example, the user interface, enabled as a mechanical dial, may be turned clockwise to continuously extend the flexible electronic screen, and counter-clock to continuously retract the flexible electronic screen 406. Alternatively, the user interface may be a touch enabled portion of the flexible electronic screen (not shown), supported by a software application stored in non-transitory memory (see FIG. 9). A variety of user interface are known in the art that would likewise be applicable.

FIG. 6 is a partial cross-sectional view of a second exemplary detail of the first screen extension mechanism. In this aspect, the first screen extension mechanism 416 comprises a return spring 600, and a roller 506 connected to the return string. The roller 506 has a surface 508 connected to the first flexible screen interior edge 408. The roller 506 is configured to rotate in a first direction 602 in response to an action extending a first flexible electronic screen exterior edge 606 away from the case, and to rotate in a second direction 604 in response to the return spring 600. The exposed section of the first flexible electronic screen is responsive to the extension of the first flexible screen exterior edge 606. The image scaler 418 accepts screen width measurements from a component such as an optical reader (424, see FIG. 4A) or a tension measurement device 608 connected to the return spring 600.

FIG. 7 is a partial cross-sectional view of a third exemplary detail of the first screen extension mechanism. In this aspect, the first screen extension mechanism 416 comprises a crank 700 having a user input, shown as handle 702, to actuate a mechanical drive 704. A roller 506 has an end 706 connected to the crank mechanical drive 704, and a surface 508 connected to the first flexible electronic screen interior edge 408. The roller 506 is configured to rotate in response to the mechanical drive 704 being actuated. In this manner, the exposed section of the first flexible electronic screen is responsive to the rotation of the roller 506. The image scaler (not shown) may accepts screen width measurements from an optical reader (424, see FIG. 4A), making a detection based upon roller position, a flexible electronic screen position, or crank position.

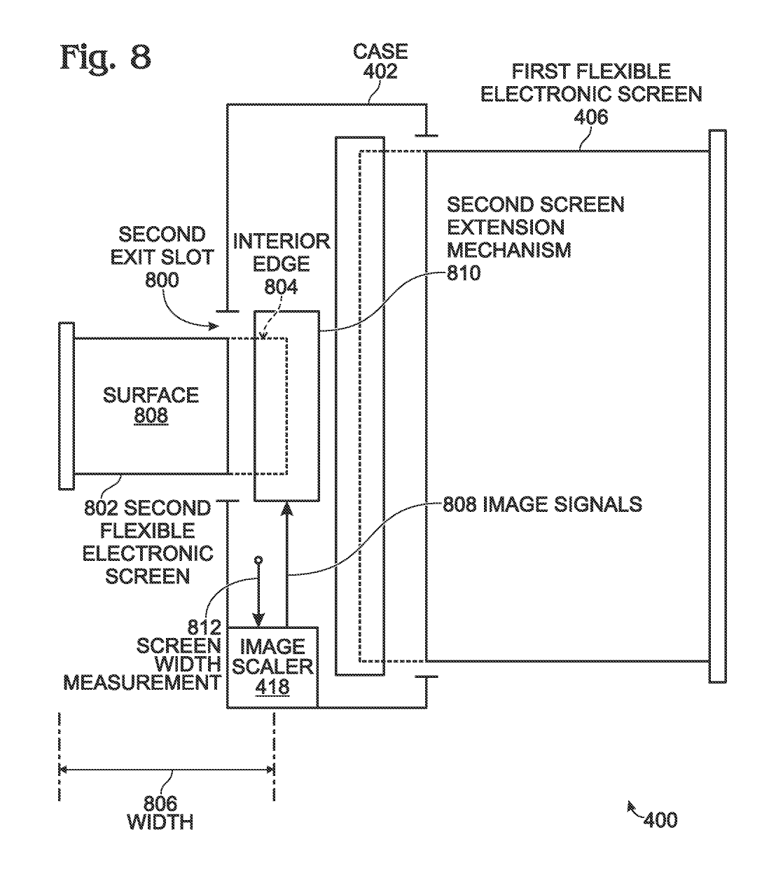

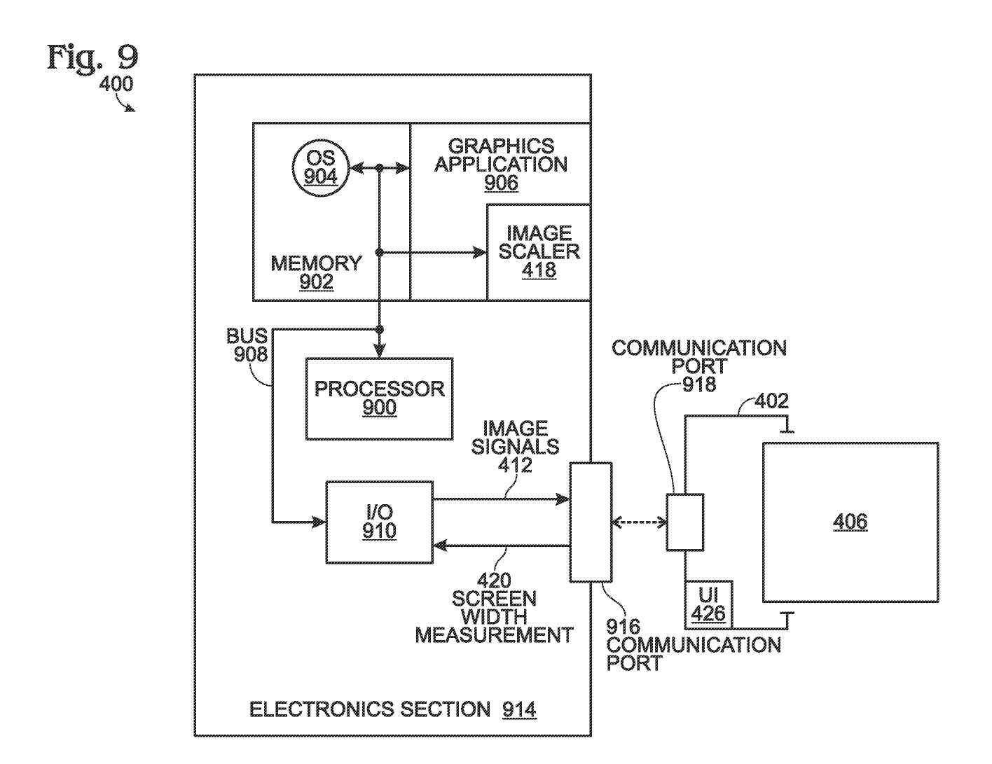

FIG. 8 is a plan view of a scrollable display with dual flexible electronic screens. In this aspect the case 402 includes a second exit slot 800. A second flexible electronic screen 802 has an interior edge 804, a width 806, an input on line 808 to accept electronic image signals, and a surface 808 to display images. A second screen extension mechanism 810 is embedded in the case 402 and is connected to the second flexible electronic screen interior edge 804. The screen extension mechanism 810 is configured to permit the extension of the second flexible electronic screen 802 through the second exit slot 800.

In one aspect, the first flexible electronic screen 406 is extendable into a plurality of exposed sections, as described above, and the second flexible electronic screen extends to just one position, meaning that the second flexible electronic screen is either fully extended from the case or fully retracted into the case. In this case, the image scaler 418 need not be connected to the second flexible electronic screen 802. In another aspect, the second screen extension mechanism 810 permits the extension of the second flexible electronic screen 802, through the second exit slot 800, in a plurality of exposed widths. In this case, the image scaler 418 accepts a screen width measurement on line 812 corresponding to an exposed width of the second flexible electronic screen 802, and supplies electronic image signals on line 808 scaled to the screen width measurement, to form an image on an exposed section of the second flexible electronic screen. As another alternative, both the first flexible electronic screen 406 and second flexible electronic screen 802 extend to just one position, meaning that the first and second flexible electronic screens are either fully extended from the case or fully retracted into the case. In this case, the image scaler 418 need not be connected to either the first flexible electronic screen 406 or the second flexible electronic screen 802.

Although the second flexible electronic screen 802 is depicted as being smaller than the first flexible electronic screen, the two screens may be the same size, or the second flexible electronic screen may be larger than the first. In one aspect, the first flexible electronic screen 406 includes a first array of pixels capable of projecting images with a first image resolution. The second flexible electronic screen 802 includes a second array of pixels capable of projecting images with a second image resolution, greater than the first image resolution. Alternatively stated, the pixels per inch (ppi) of the second flexible electronic screen 802 may be greater than the ppi of the first flexible electronic screen 406.

FIG. 9 is a schematic diagram depicting some exemplary electronic functions that may support any of the above-described displays. For example, the display 400 may comprise a processor 900 and a non-transitory memory 902. The non-transitory memory 902 may be referred to as a computer-readable medium. An operating system (OS) 904, enabled as a sequence of processor executable software instructions, is stored in the non-transitory memory 902. A graphics application 906, enabled as a sequence of processor executable software instructions, is stored in the non-transitory memory 902, to supply images to the first flexible electronic screen. The image scaler 418 may be either incorporated into the graphics application 906, as shown, or be a separate software application enabled as a sequence of software instructions executed by the processor 900. Although not shown, a special purpose graphics processor, application-specific integrated circuit (ASIC), or system-on-chip (SoC) may also be employed. The processor 900 and memory 902 are connected by a bus 908, using a Serial ATA (SATA), an Industry Standard Architecture (ISA), a Peripheral Component Interconnect PCI), a PCI Express (PCIe), or other suitable message format. The bus 908 is also connected to an input/output (I/O) 910, connected to accept screen width measurements on line 420 and to send electronic image signals on line 412. The I/O or I/O controller 910 generally represents any type or form of device or module capable of coordinating and/or controlling the input and output functions of a computing device, controlling and facilitating data transfer between the processor 900, memory 902, and communication port 916. In another aspect not shown, the I/O may be connected to the user interface to receive user commands and to supply extension commands.

Electronics section 914 has a communications port 916 connected to a communications port 918 of the case 402. In one aspect, the communication ports 916/918 are simply hardwired together, in which case the electronics section 914 is typically embedded in the case 402. Alternatively, the communication ports 916/918 are wire harness connectors, in which case the electronics section 914 may be selectively engagable with the case 402. In another aspect, the communication ports 916/918 are wirelessly connected using, for example, a Bluetooth or IEEE 802.11 or 802.3 protocol.

Although the electronic functions have been described as being enabled with software, it should be understood that some, or all of the above-mentioned functions may be enabled in state machine logic using, for example, a field programmable gate array (FPGA). The display is not limited to any particular means of electronic control.

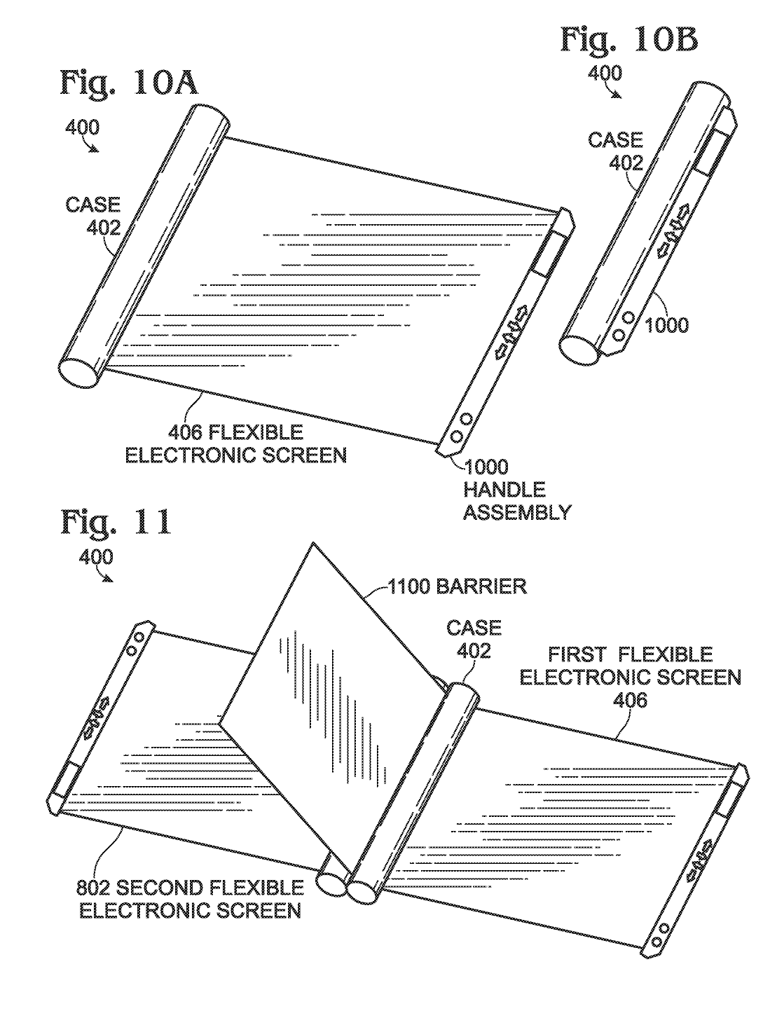

FIGS. 10A and 10B are perspective views of an exemplary scrollable display in open and closed positions. In general, the above-described compact display system enables, on demand, the deployment of a working flexible electronic screen surface that can be retracted back to a housing unit or case for easy transport and storage. In its basic form, the system consists of one or more flexible electronic screen surface(s) connected to a housing unit, in a manner that enables extension or retraction of the flexible electronic screen surface(s) from or to the housing unit. As shown in this example, the system has a single flexible electronic screen 406 attached to a housing unit. The flexible electronic screen 406 is attached to the interior of the housing unit, to a rotating mechanism that allows the surface to roll and unroll based on input from the user. The non-attached end of the display features a “handle” assembly 1000 that facilitates handling and includes a number of electronic controls—for example, ON/OFF button, cursors to emulate a mouse, small digital display to display various systems messages, the date/time, etc.

FIG. 11 is a perspective view of a scrollable display with two flexible electronic screens. For applications where additional working surface is required—for example, to facilitate a collaborative project, games that require separate surfaces, or a number of other possibilities, a display may feature two flexible electronic screen surfaces, first and second flexible electronics screens 406 and 802, which are deployed from diametrically opposite ends of the case (housing unit) 402. The case 402 is modified to accommodate the two rolling surfaces. For example, game applications such as “air hockey”, or “battleship” may be enabled by raising a barrier 1100 in the middle to provide visual isolation of each surface. In that sense, the display 400 can be used in competing games (leisure or educational) where each “side” is given a task to complete and must do so, without knowing the strategy employed by the other side.

The dual flexible electronic screen display can also be adopted for applications that can benefit from having a combination of displays tailored to specific functions. For example, such a display can feature one flexible electronic screen optimized for e-book reading and a second flexible electronic screen optimized for color and motion. These flexible electronic screens can be certainly similarly sized, but can also be scaled according to their function. For example, the high resolution flexible electronic screen may be smaller in size. In this particular aspect, the large flexible electronic screen 406 is optimized for document (e.g. book) reading (hence may be monochrome), whereas the small flexible electronic screen 802 is optimized for color and motion (e.g. video and photo viewer, video-phone, etc.). For example, flexible electronic screen 406 can be electrophoretic, whereas the second flexible electronic screen 802 can be organic light emitting diode (OLED). Such a display permits multitasking, with the two flexible electronic screens functioning in “collaboration” mode, or in “independent” mode.

An example of collaboration mode is a situation where the large flexible electronic screen 406 serves as a “desktop” and with the flick of the finger the user “drops” an object to the small flexible electronic screen 802 for better viewing and additional editing. An example of independent mode is a situation where a user reads an e-book using second flexible electronic screen 802 on the left and answers a video-call using the flexible electronic screen 406 on the right.

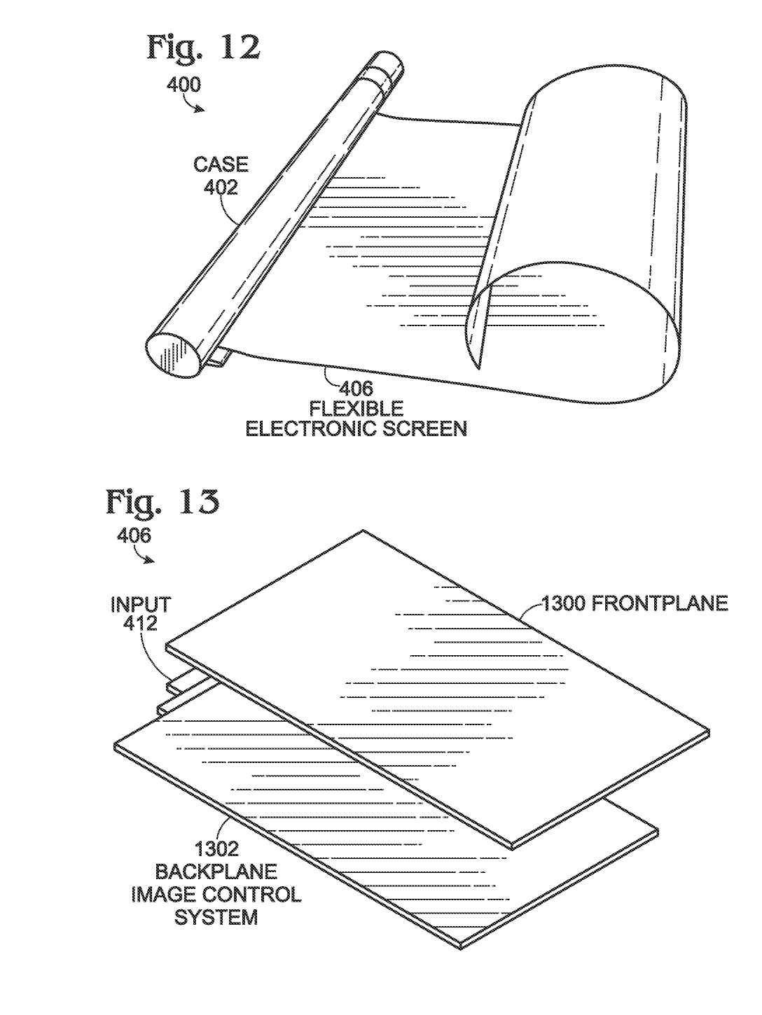

FIG. 12 is a perspective drawing depicting the scrollable display as an electronic blueprint device. The “working surface” of the first flexible electronic display 406 is primarily used to display, present, edit, and generally manipulate blueprints. It may be rectangular in shape with a diagonal in the range of 40-50″ and sides in the range of 20 inches-40 inches. The base unit or case 402 serves as a housing for the rolled up flexible electronic screen 406 surface, as well as, a hub for various electronic components needed to control the operation of the display and the acquisition and distribution of its contents (e.g., WiFi connection, Bluetooth, etc.). When not needed deployed, the flexible electronic screen 406 surface can be retracted back to the base unit 402. For example, the case 402 may be a compact cylindrical shape with a diameter ranging from 2 inches to 4 inches.

The pulling/pushing end of the flexible electronic screen 406 may equipped with a sort of handle (1000, see FIG. 10A) that provides for a robust and comfortable means of conducting these operations. The handle may also play the role of a protective casing for electronics that are embedded at the edge of the surface. In addition, the handle may itself carry means (e.g. real or virtual buttons) that allow the user to perform certain functions (e.g. deployment and retraction of the surface, initialization of the display, virtual mouse, etc., or may contain sub-components useful to the operation of the surface (i.e. have an electronic stylus stored in the handle that can be removed on demand).

As far as receiving input from a user, a touch sensor may be attached to the top surface of the flexible electronic screen surface 414. For example, the touch sensor (not shown) may have a resolution in the range of 15 to 50 ppi. The touch sensor may be configured to receive finger, pen (stylus), and/or multi-touch input. This sensor may be made with a variety of technologies, such as resistive touch or projected capacitance. Other touch technologies are also viable, especially if they support multi-touch. Multi-touch is important from the point of view of user interaction (i.e. having at least two users working on the same project), and from the point of view of convenience in interacting with the device (i.e. use two-touch contact to size objects, etc.).

FIG. 13 is a perspective view of an exemplary flexible electronic screen. The first flexible electronic screen may comprise a frontplane light emission component 1300 and a backplane image control system 1302. In a typical device, the frontplane 1300 is laminated on the backplane 1302. The frontplane is typically 0.05 to 0.2 millimeters (mm), as is the backplane dimensions. The frontplane 1300 may also include an integrated touch sensor. Alternatively, the touch sensor may be separately laminated on the top surface of the frontplane/backplane assembly.

In one aspect, the frontplane 1300 is a reflective device, where images are formed without the need of an internal light source and the appearance of such images is insensitive to lighting conditions and to viewing angle. These are typical characteristics of so-called “e-paper” (“electronic paper”) display technologies. Due to the need for that the flexible electronic screen surface flex and roll, it may be difficult to employ display technologies that require precise control of the critical dimensions between layers (e.g. cell gap in liquid crystal displays (LCDs)), or require several laminated layers to achieve uniform illumination characteristics to the panel (e.g. backlight modules for transmissive displays). Moreover, the need for relatively wide viewing angle characteristics can be easily met with e-paper technologies, whereas transmissive displays typically require increased component complexity or added layers. One additional, advantageous characteristic of many reflective displays is their very low power consumption property. For example, since the digital blueprint device is meant to be used primarily in the field, away from a traditional office environment, it is particularly advantageous to have a long battery life. Typical transmissive (e.g. LCD) or emissive (e.g. OLED) display technologies tend to consume significant amount of power to both maintain and change images. In contrast, many of e-paper display technologies tend to be very power savvy, due to their fundamental bistability (i.e. power is consumed only to change an image and no power is consumed in order to maintain an image).

One disadvantage of conventional e-paper type displays is the lack of a wide color gamut (i.e. equivalent to that of emissive or transmissive displays). However, for many applications (e.g. blueprints) only a monochrome display is needed, which is suited to several reflective display types. An additional disadvantage of conventional e-paper type displays is their relatively slow switching speed. This translates to a much slower refresh rate, which renders difficult the natural viewing of video. However, for the document applications, such limitation is not an issue. Some examples of “e-paper type” reflective technologies include, among others, the electrophoretic, electrowetting, and electrofluidic devices described in the Background Section.

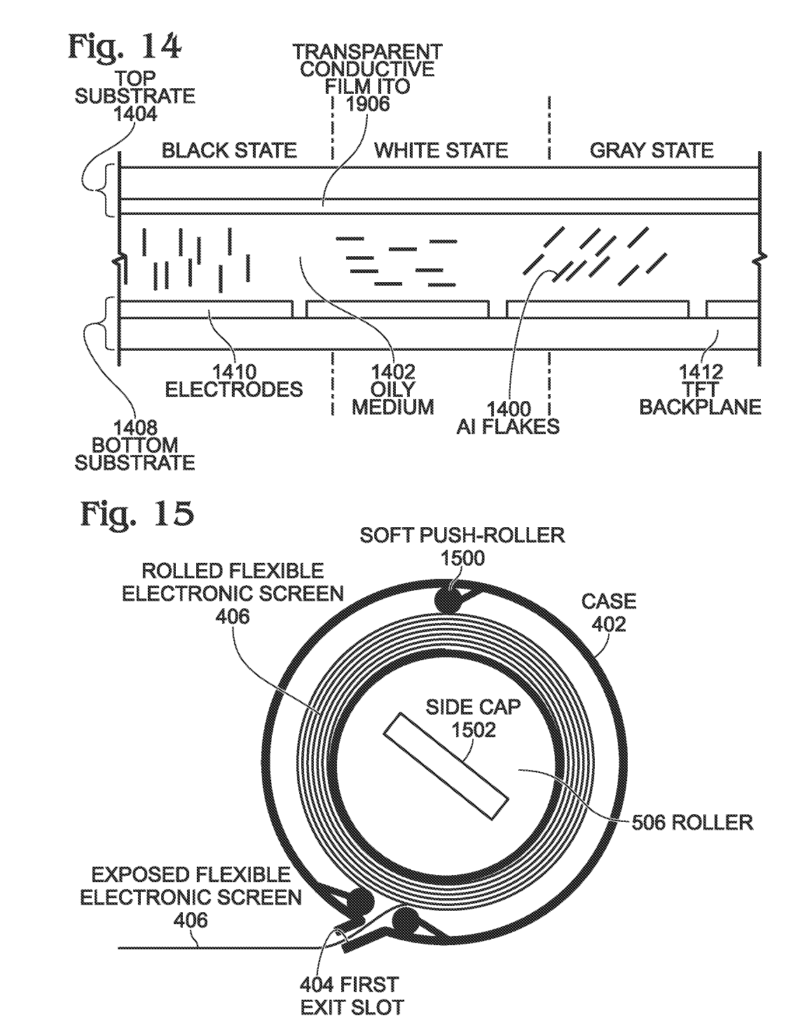

FIG. 14 is a partial cross-sectional view of a flake display reflective device. Aluminum (Al) flakes 1400 (10-100 μm long/wide) are dispersed in an oily medium 1402. The flakes 1400 and medium 1402 are encapsulated between two substrates. The top substrate 1404 features a continuous, transparent conductive film 1406 (e.g. ITO) at its interior surface. The bottom substrate 1408 has patterned electrodes 1410 that are connected to the pixels of the TFT backplane 1412. When there is sufficient voltage applied across the cell, the resulting electric field causes the Al flakes 1400 to rotate and form a reflective surface that reflects incoming light back to the user (white state). In the absence of voltage, the Al flakes 1400 remain approximately vertically suspended in the medium 1402 allowing light to go through and be absorbed at the bottom electrodes (black state). Voltage values between the two states cause partial rotation of the Al flakes 1400, thus resulting in the creation of gray scales. The one advantage of this technology is the very bright white state, which provides for a viewing experience very close to natural paper.

Table 1 compares the ideal characteristics of reflective display devices. From the comparison, it appears that EF is a preferable embodiment, followed by the “flake” display. EPD technology may also be suitable, especially if time-to-market is priority.

TABLE 1

| | Speci- | | | | |
|---|---|---|---|---|---|
| | fication | | | | |
| Parameter | (“Ideal | | | | |
| Value | Case”) | EPD | EW | EF | “Flake” |
| % R for | >75% | 30-40% | 55% | 70% | 50% |
| White | | | | | |
| State | | | | | |
| Contrast | >20:1 | 10:1 | 15:1 | ? | 40:1 |
| Ratio | | | | | |
| Bistable | Yes | Yes | No | Yes | No |
| Switching | <100 msec | 30 msec | 10 msec | 10-15 msec | 100 msec |
| Speed | | | | | (?) |
| Flexible | Yes | Yes | Unclear | Yes | Unclear |
| Years in | | Mature, | ~10 | ~3 | ~1 |
| Development | | Many | | | |
| | | Products | | | |

Regardless of whether the frontplane is laminated on top of the backplane or becomes integrated within the backplane structure, the backplane is the system that enables localized control of the light characteristics and, hence, is responsible for the formation of actual shapes and forms on the display surface. To that end, the backplane comprises a plurality of replicating units that form “pixels”. The size of the pixel is fundamentally related to the resolution of the display, or its ability to accurately reproduce fine features. The higher the resolution, the more accurately an image can be displayed. A minimum resolution of at least 100 ppi is required for many applications, while resolutions of 200 ppi or even 300 ppi may be useful for special applications. For a 100 ppi panel, the corresponding pixel size for a flexible electronic screen surface is 254 μm×254 μm (horizontal×vertical), while the pixel size is 127 μm×127 μm for a 200 ppi panel, and 85 μm×85 μm for a 300 ppi panel. Within each pixel there are further elements that enable the generation of control signals (e.g. a voltage output), in response to number of input signals. The input signals are transmitted to each pixel via a grid consisting of intersecting horizontal and vertical conducting, metal lines. The output signals are transmitted to the light controlling subsystem (i.e. frontplane) via direct connections between each pixel and the light controlling element. Typically the combination of the metal conductor grid, along with the specific elements within each pixel, is termed as the “array” and the array becomes the key component of the backplane. Additional elements may be monolithically integrated onto the backplane. For example, the electronics supplying at least one of the controlling signals to the array (e.g. gate drivers) may monolithically integrated onto the backplane for increased reliability, especially for a flexible device.

Another aspect of the scrollable display is a means to ensure against various environmental, as well as, handling conditions. For example, when deployed, the flexible electronic screen surface should be protected against intentional/unintentional mishandling (e.g. excessive bending). In addition, the flexible electronic screen should function under a variety of environmental conditions and be protected against the elements (i.e. rain, humidity, dust, dirt, etc.). To that end, the flexible electronic screen and any other exposed system components may have optional coatings that provide for self-cleaning functions. Moreover, the case may be equipped with various implements that allow the flexible electronic screen surface to be cleaned of debris and/or dust as it retracts to its housing. There are many possible designs to achieve such cleaning action, including the addition of sections with bristles, etc. One further measure of value is the optional addition of a “backing mat” layer that mitigates the adherence of dirt to the back of the display surface (e.g., Teflon-based or silicone mat). Such a mat can also counter the natural propensity of the flexible electronic screen to “curl” especially along its edges. By properly selecting the backing thickness (e.g. less than 1 mm) good rolling characteristics can be achieved for the surface.

FIG. 15 is a partial cross-sectional view of the scrollable display with the flexible electronic screen partially retracted. The roller 506 may have a number of functions, such as housing various electronic components, deploying and retracting the electronic flexible electronic screen 406, protecting the flexible electronic screen when retracted for storage. A number of soft push rollers 1500 can be attached to the interior surface case 402, to keep the flexible electronic screen 406 tightly wound around the interior moving roller 506 and to facilitate the operations of rolling and unrolling. The interior moving roller extends throughout the length of the exterior casing. Removable side caps 1502 at both ends of the interior moving roller 506 may allow access to its interior compartments. The interior of the moving roller 506 may contain various electronic boards, a motor, as well as a battery compartment. One end of the roller may include hookups for power and other (optional) connections, such as universal serial bus (USB). Although the case 402 is shown as circular in cross section, other cross-sectional shapes are also possible, such as triangular or polygonal. However, a cylindrical roller is more likely to ensures a uniform radius of curvature and, hence, uniform mechanical stress for the rolled flexible electronic screen.

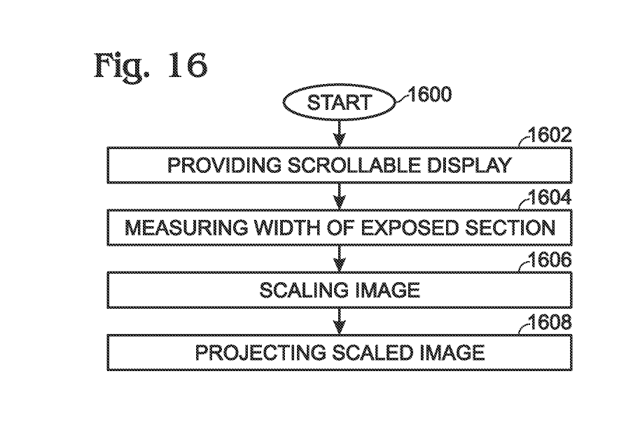

FIG. 16 is a flowchart illustrating a method for displaying an image having a selectable image width. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. Generally however, the method follows the numeric order of the depicted steps. The method starts at Step 1600.

Step 1602 provides a scrollable display having a flexible electronic display, such as described above in the explanation of FIGS. 4A-4D. Step 1604 measures a width of an exposed section of the flexible electronic display extending from a case. Here it should be understood that a width may be predetermined, and therefore measured, based upon the flexible electronic screen being extended a predetermined extent from the case. In response to measuring (Step 1604), Step 1606 scales an image to fit in the exposed section. Step 1608 projects (displays) the scaled image from the exposed section of the flexible electronic display.

A scrollable display and associated image scaling method have been provided. Examples of particular display types, control means, and mechanical structures have been presented to illustrate the invention. However, the invention is not limited to merely these examples. Although the scrollable display has been described as being extendable from a protective case, it should be understood that the display may be enabled without a case, more in the manner of a conventional paper scroll. Other variations and embodiments of the invention will occur to those skilled in the art.

We claim:

1. A scrollable display with adjustable screen size, the display comprising:
a case including a first exit slot;
a first flexible electronic screen having an interior edge, a width, an input to accept electronic image signals, and a surface to display images;
a first screen extension mechanism embedded in the case and connected to the first flexible electronic screen interior edge, the first screen extension mechanism configured to permit the extension of the first flexible electronic screen, through the first exit slot, into a plurality of exposed widths; and,
an image scaler having an input to accept a screen width measurement corresponding to an exposed width of the first flexible electronic screen, and an output to supply electronic image signals scaled to the screen width measurement, to form an image on an exposed section of the first flexible electronic screen.

2. The scrollable display of claim 1 wherein the first screen extension mechanism comprises:
a stepper motor having an electronic interface to accept extension commands, and a mechanical drive;
a roller connected to the stepper motor mechanical drive, with a surface connected to the first flexible screen interior edge, the roller configured to rotate in response to extension commands; and,
wherein the exposed section of the first flexible electronic screen is responsive to the rotation of the roller.

3. The scrollable display of claim 2 wherein the image scaler accepts screen width measurements from a component selected from a group consisting of the stepper motor and an optical reader.

4. The scrollable display of claim 2 further comprising:
a user interface having an output to supply the extension commands, and an input to accept user commands selected from a group consisting of a predetermined discrete number of user input options and a continuously sequential number of user input options between a maximum exposure width and a minimum exposure width.

5. The scrollable display of claim 1 wherein the image scaler accepts screen width measurements selected from a group consisting of a predetermined discrete number of different screen width measurements and a continuously sequential different number of screen width measurements between a maximum screen width measurement and a minimum screen width measurement.

6. The scrollable display of claim 1 wherein the first screen extension mechanism extends the exposed sections of the first flexible electronic display as selected from a group consisting of a predetermined discrete number of different exposed sections and a continuously sequential number of different exposed sections between a minimum exposed section and a maximum exposed section.

7. The scrollable display of claim 1 wherein the image scaler supplies electronic image signals to scale images selected from a group consisting of a predetermined discrete number of different scaled images and a continuously sequential number of different scaled images between a minimum sized image and a maximum sized screen image.

8. The scrollable display of claim 1 wherein the first screen extension mechanism comprises:
a return spring;
a roller connected to the return string, with a surface connected to the first flexible screen interior edge, the roller configured to rotate in a first direction in response to an action extending a first flexible electronic screen exterior edge away from the case, and to rotate in a second direction in response to the return spring; and,
wherein the exposed section of the first flexible electronic screen is responsive to the extension of the first flexible screen exterior edge.

9. The scrollable display of claim 8 wherein the image scaler accepts screen width measurements from a component selected from a group consisting of an optical reader and a tension measurement device connected to the return spring.

10. The scrollable display of claim 1 wherein the first screen extension mechanism comprises:
a crank having a user input to actuate a mechanical drive;
a roller having an end connected to the crank mechanical drive, with a surface connected to the first flexible electronic screen interior edge, the roller configured to rotate in response to the mechanical drive being actuated; and,
wherein the exposed section of the first flexible electronic screen is responsive to the rotation of the roller.

11. The scrollable display of claim 10 wherein the image scaler accepts screen width measurements from an optical reader making a detection selected from a group consisting of a roller position, a flexible electronic screen position, and a crank position.

12. The scrollable display of claim 1 wherein the case includes a second exit slot;
the scrollable display further comprising:
a second flexible electronic screen having an interior edge, a width, an input to accept electronic image signals, and a surface to display images; and,
a second screen extension mechanism embedded in the case and connected to the second flexible electronic screen interior edge, the screen extension mechanism configured to permit the extension of the second flexible electronic screen through the second exit slot.

13. The scrollable display of claim 12 wherein the second screen extension mechanism permits the extension of the second flexible electronic screen, through the second exit slot, into a plurality of exposed widths; and,
wherein the image scaler accepts a screen width measurement corresponding to an exposed width of the second flexible electronic screen, and an output to supply electronic image signals scaled to the screen width measurement, to form an image on an exposed section of the second flexible electronic screen.

14. The scrollable display of claim 12 wherein the first flexible electronic screen includes a first array of pixels capable of projecting images with a first image resolution; and,
wherein the second flexible electronic screen includes a second array of pixels capable of projecting images with a second image resolution, greater than the first image resolution.

15. The scrollable display of claim 1 further comprising:
a processor;
a non-transitory memory;
an operating system enabled as a sequence of processor executable software instructions stored in the non-transitory memory; and,
a graphics application enabled as a sequence of processor executable software instructions stored in the non-transitory memory, to supply images to the first flexible electronic screen.

16. A display with dual scrollable screens, the display comprising:
a case including a first exit slot and a second exit slot;
a first flexible electronic screen having an interior edge, a width, an input to accept electronic image signals, and a surface to display images;
a first screen extension mechanism embedded in the case and connected to the first flexible electronic screen interior edge, the first screen extension mechanism configured to permit the extension of the first flexible electronic screen through the first exit slot;
a second flexible electronic screen having an interior edge, a width, an input to accept electronic image signals, and a surface to display images; and,
a second screen extension mechanism embedded in the case and connected to the second flexible electronic screen interior edge, the screen extension mechanism configured to permit the extension of the second flexible electronic screen through the second exit slot.

17. The scrollable display of claim 16 wherein the first screen extension mechanism permits the extension of the first flexible electronic screen, through the first exit slot, into a plurality of exposed widths;
wherein the second screen extension mechanism permits the extension of the second flexible electronic screen, through the second exit slot, into a plurality of exposed widths; and,
the scrollable display further comprising:
an image scaler having an input to accept screen width measurements corresponding to exposed widths of the first and second flexible electronic screens, and an output to supply electronic image signals scaled to the screen width measurement, to form an image on exposed sections of the first and second flexible electronic screen.

18. The scrollable display of claim 16 wherein the first flexible electronic screen includes a first array of pixels capable of projecting images with a first image resolution; and,
wherein the second flexible electronic screen includes a second array of pixels capable of projecting images with a second image resolution, greater than the first image resolution.

19. A method for displaying an image having a selectable image width, the method comprising:
providing a scrollable display having a flexible electronic display;
measuring a width of an exposed section of the flexible electronic display extending from a case;
in response to measuring, scaling an image to fit in the exposed section; and,
projecting the scaled image from the exposed section of the flexible electronic display.
